(19) United States
(12) Patent Application Publication
(10) Pub. No.: US 2003/0151926 A1
(43) Pub. Date: Aug. 14, 2003

(54) Light-emitting articles, in particular glasses and other articles for parties and other uses

(76) Inventors: Christophe Mermaz, Luton (GB); Dominique Pecquet, Luton (GB)

Correspondence Address: Christophe Mermaz, Light Emotions, Britannia House, Leagrave Road, Luton Bedfordshire, LU3 1RJ, GB

(21) Appl. No.: 10/240,252

(22) PCT Filed: Oct. 4, 2001
(86) PCT No.: PCT/FR01/00914

(30) Foreign Application Priority Data
Mar. 29, 2000 (FR) 00 04243

(51) Int. Cl. F21S 4/00

(52) U.S. Cl. 362/565

(57) ABSTRACT

The invention concerns a disposable small-size light-emitting device (1) comprising a light source (3); an integrated electronic control module (4), and a power source (5), said electronic control module including means (6) for reducing power consumption of said electronic module and or of said light-emiitting elements, when stored and not in use, and optionally means (7), reducing their inertia on being switched on, and means (8) for switching on/off said light sources. The invention is adaptable and capable of being integrated in all types of disposable light-emitting articles, for fun or not such as for instance glasses, lighters, decorative objects.

### TECHNICAL AREA OF THE INVENTION

The invention concerns the technical field of disposable products for parties and all sorts of other purposes, as explained below in details, and which has the characteristic of glowing-in-the-dark at least temporally.

The invention concerns in particular but in a non-exhaustive manner, disposable glasses and other disposable receptacles for beverages.

Existing Patents

We are aware of a patent FR2 772 886, which describes a glow-in-the-dark glass with a base, which holds a removable glow-in-the-dark system with battery, electric bulb and reflector.

We are aware of a patent U.S. Pat. No. 4,922,355, which describes a cup with a base, which holds the same type of electronic device as the above patent FR2 772 886. This has an on/off switch using contacts (34) and (35) which close the circuit when liquid is present or when the hand is on the handle.

We are aware of another patent EP 0 231 471, which describes a cup similar to patent FR2 772 886 and U.S. Pat. No. 4,922,355 described above, i.e. with a removable system included in the base and controlled by a switch.

Finally we are aware of the patent FR 98 03856, which describes a cup whose base contains a removable system with a battery and LED as in the former patents. This system incorporates a technical improvement i.e. the use of a LED and a special shape at the bottom of the glass to hole the residual liquid.

All the above systems describe products, which include a removable system inside the base of the glass. On all of these systems the batteries can be replaced when they are worn out.

A previous patent of ours, FR 0000 429 of Jan. 13, 2000, refers to a glow-in-the-dark device, which is stuck in with glue or embedded in resin. This system is disposable but is not easily adaptable to all kind of glasses. The disadvantage of this system is that its storage life is short because it consumes electrical energy even when not in use. Therefore, such products have a short shelf life.

This last characteristic is the real problem, especially if we take into account the necessity to achieve a cost extremely low. According to the applicants, the only system able to answer to these requirements is the system described in the current patent application that is the subject of this document.

In addition to the patents described above, there are other publications on this subject, which are at a theoretical project stage being impossible to realise commercially due to technical, industrial or commercial reasons. These have not been taken into account when looking at prior claims.

We have not been able to identify anybody else who has made a glow-in-the-dark system of small size, or very small size, which is disposable and not removable, for which the manufacture cost remains low and which could be stored for a long term in boxes or between use, without loosing its power (no consumption when the system is switched off).

By small or very small size, we mean having dimensions enabling them to be integrated in the base of a glass, a light, a small decorative item, or even products that can be attached to the clothes, etc.

By long-term storage, we mean storage of around two years or more (which fits with the battery manufacturer guarantee). During this period the initial power of the batteries is maintained, in contrast to all known current glow-in-the-dark similar system, which would have lost in the best storage conditions at least half of its initial power by one year and all of the power within 18 to 24 months. The systems that we currently know of loose their power between two utilisations of the product by the customer.

There is a recognised and important need and demand from professional involved in glow-in-the-dark product market for disposable glow-in-the-dark products which meet the criteria described above. We understand that the demanding characteristics of such glow-in-the-dark products explain the absence of such products on the market today.

### INVENTION SUMMARY

The merit of the applicants is to have overcome the technical difficulties explained above and to have designed and finalise a small or very small disposable system with an extremely long shelf life before and after the purchase and adaptable to all kind of party products or other products, such as glasses, concert lights, inside and outside decorative items, etc, for which a non exhaustive list will be given below.

### DETAILED DESCRIPTION OF THE INVENTION

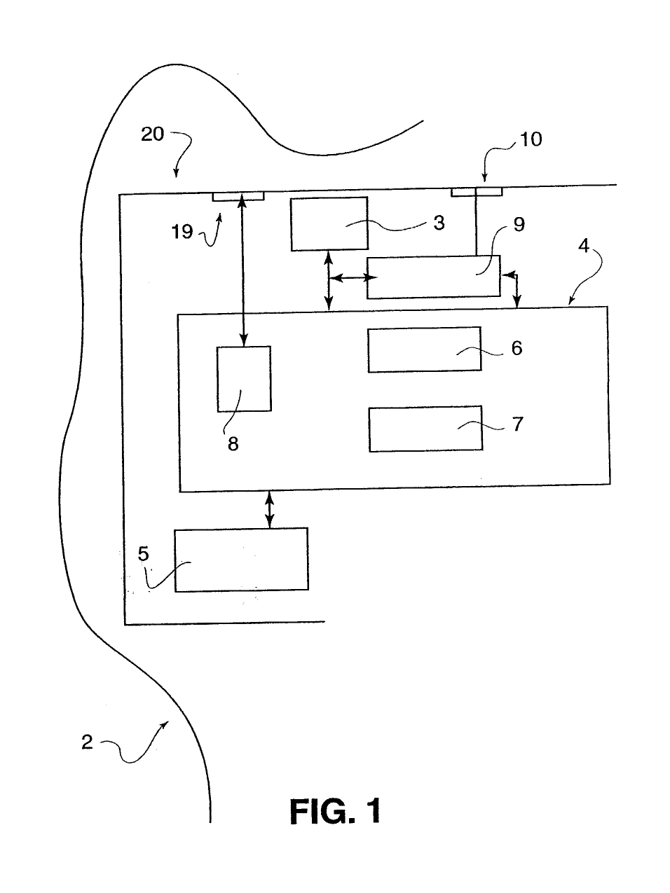

FIG. 1 refers. The invention is composed of a glow-in-the-dark device 1, independent, of a small, or very small size, adaptable or integratable in an item (2) of any kind. The device 1 is composed of at least one light source (3), at least one control electronic (4) and at least one power source (5); The control electronic is composed of a device (6) which reduces to zero the electricity consumption of the electronic device, the lighting system and of all the existing components during storage or when the system is switched off Eventually the control electronic will have a device (7), which reduces the time it takes to light up after a storage period and a device (8) which would control the illumination and extinction of light in response to external stimuli, for instance picked up through sensors (19).

The system is preferably packaged in a box (20).

Preferably, the electronic device (4) will include a device (9), which controls flashing of the light, modulation of the power of the light, enabling us to perform flashes, sparks and other similar effects. These effects will eventually be in response (through one or many sensors (10)) to external stimuli such as sounds, and/or visuals, and/or temperature etc. For instance this could be synchronised with sound level and/or external light, and/or similar effects.

Preferably, these sensors (10) will be specifically related to the particular stimuli such as brightness, contrast, sound frequency i.e. finger snapping, or external sound of the room, or variation of such stimuli.

The sensor(s) (19) can be all type of sensors able to send a signal to the electronic (4) and more precisely to the illumination/extinction module (8). These are for instance humidity sensors, temperature sensors or contacts that close the circuit when a liquid is present, or similar systems.

Preferably, sensors (19) and/or (10) will be positioned outside of the surface of the article (2) or close to the surface of article (2).

By “electrical consumption reduces to zero” we mean consumption in storage and out of use which are nil or extremely low, between 0,000 A/h to 0,00001 A/h, or few microamperes /h, and allow the shelf life expectancy expressed above.

Preferably the device 8 includes a “Darlington” transistor.

A “Darlington” transistor is a transistor, which is able to switch high current with a very low control current (double transistor, high gain).

This transistor has been known for at least 20 years, but nobody has used it in the context of this patent application. This is the merit of the applicants to have selected this item to perform astonishing applications, which solved the long-term technical problem of storage that had remained unsolved despite an existing demand on the market.

Preferably, the “Darlington” transistor is polarized with selected electronic components and arranged so that it is maintained in an inactive state (that means a conductivity of nil) when the system is stored or not in use.

We are aware of existing electronic system, which could reach the same result, but none of them can be adapted to the obliged requirements, especially as cost, size and similar considerations are concerned.

Preferably, the “Darlington” transistor is also polarised with electrical components similar or different from the previous ones and selected and adjusted so that the illumination of the system requires a very small current of polarisation of few microamperes.

Therefore, the system has not just a nil or close to nil consumption when stored or out of work, but it can activate the lighting source(s) instantly or quite iinstantly after a long stored period, that means after the first use or after a multi time uses in a short period or a multi time uses in a long term period.

One of the technical problems regarding glow electronic disposable system is their time to illumination, which appears when we want to reduce their current consumption when the system is not in use. This characteristic is obviously anti commercial. The present invention is solving also this problem.

Of course, we can imagine that the illumination/extinction contacts (19) are not switching the light on when connected but are switching it off when connected. For instance the light will be on when the glass is empty and disappear when we fill up the glass with a liquid.

Other characteristics and advantages of the system described in this invention will be better understood by reading the following explanations which relates to the drawing in appendix in which:

FIG. 1 represents the general drawing of the system according to the invention, with eventually a box and integration in an article

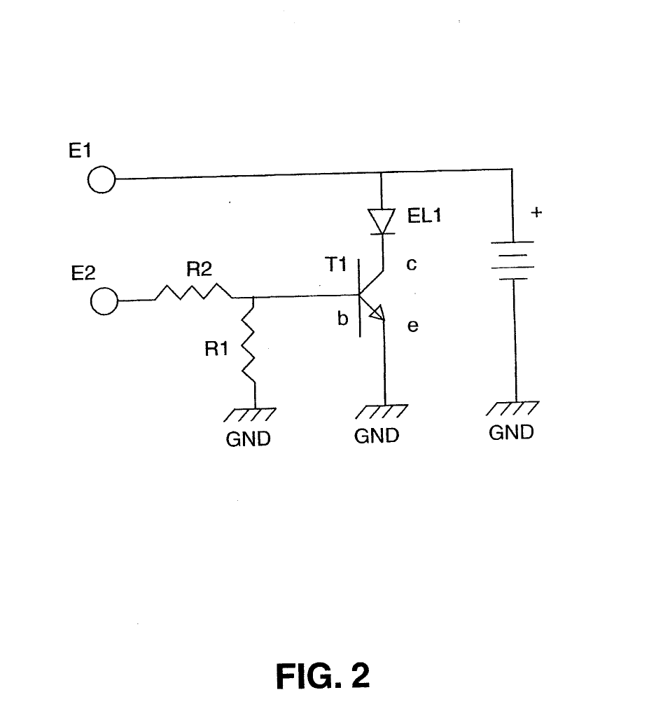

FIG. 2 represents the electronic drawing of the system describing the non-limiting applications we describe below

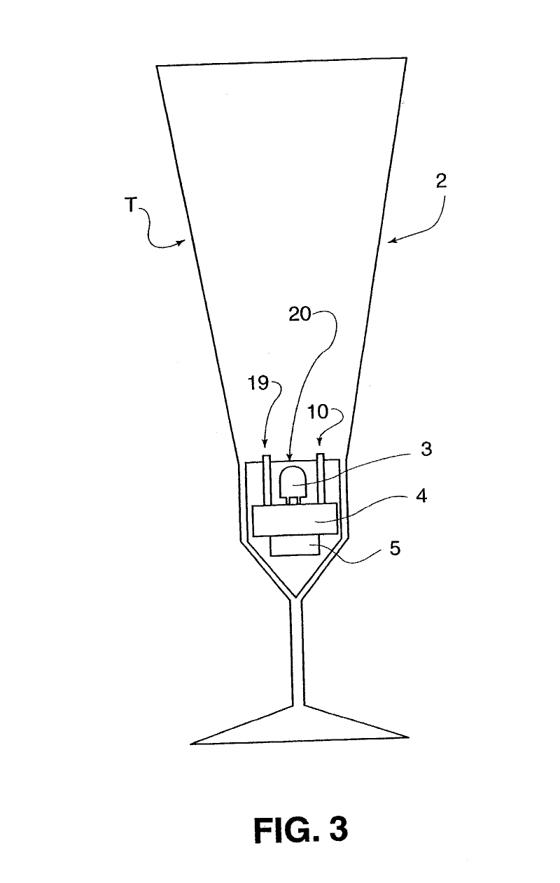

FIG. 3 represents a non-limiting application of the invention: A glass (2), the upper part of which (T) is transparent or translucent and the bottom part of which is composed of a module (20), which contains the system according to the present invention

The material of the glass could vary, such as crystal, polycarbonate, resin, other plastic materials, etc.

The system is integrated in the glass using various assembly technologies (glue, embedded resin, etc)

References (20,10,19,3,4,5) are explained above.

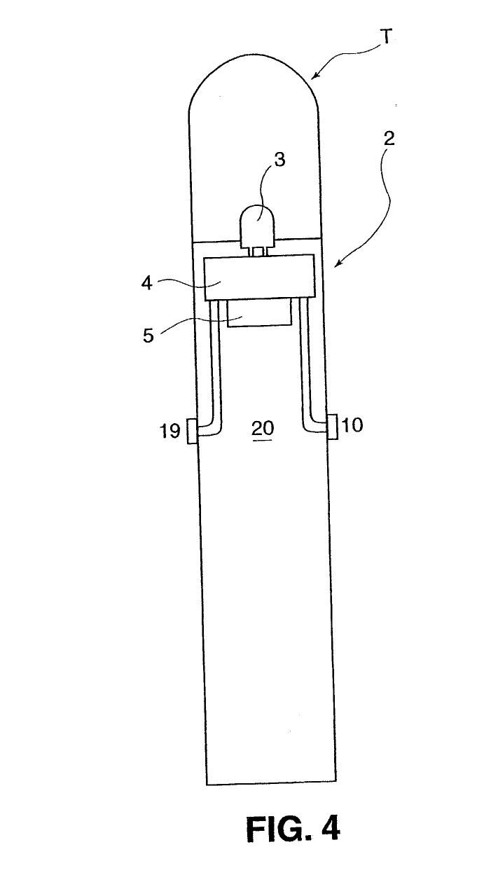

FIG. 4 represents a non limiting application of the present invention: a light or concert light (2), the upper part of which (T) is transparent or translucent and the body of which includes a module (20) including the system of the present invention.

The material of the light could vary, such as polycarbonate, resin, other plastic materials, etc . . .

The system is integrated using different assembly technologies (glue, resin embedded, etc)

References (20,10,19,3,4,5,2) are explained above.

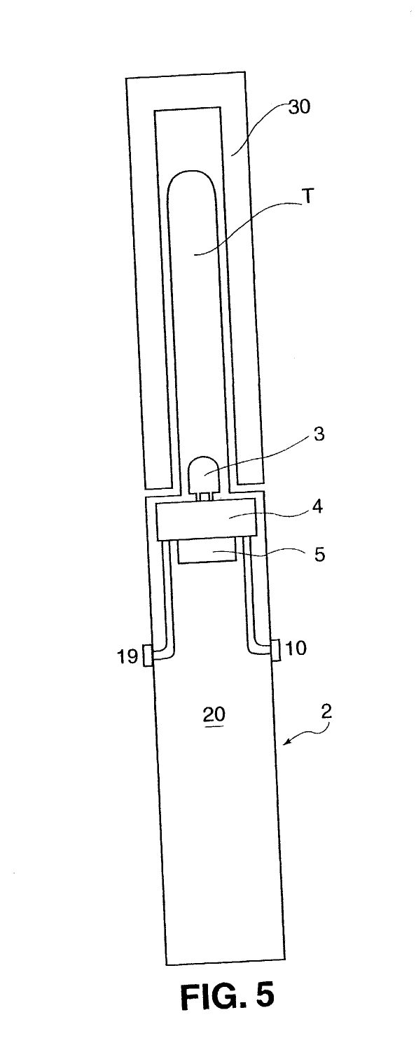

FIG. 5 represents a non limiting application of the present invention: a delicacy such as pacifier or similar (2), the upper part of which (T )is transparent or translucent and recovered with a coloured sugar (30) which is able to transmit the light from the lighting source (3), and the body of which is composed of a module (20) including the system of the present invention.

The material of the body of the article could vary, such as polycarbonate, resin, compressed paper, cardboard or other plastic materials, etc

The system is integrated using different assembly technologies (glue, resin embedded, etc)

References (20,10,19,3,4,5,2) are explained above.

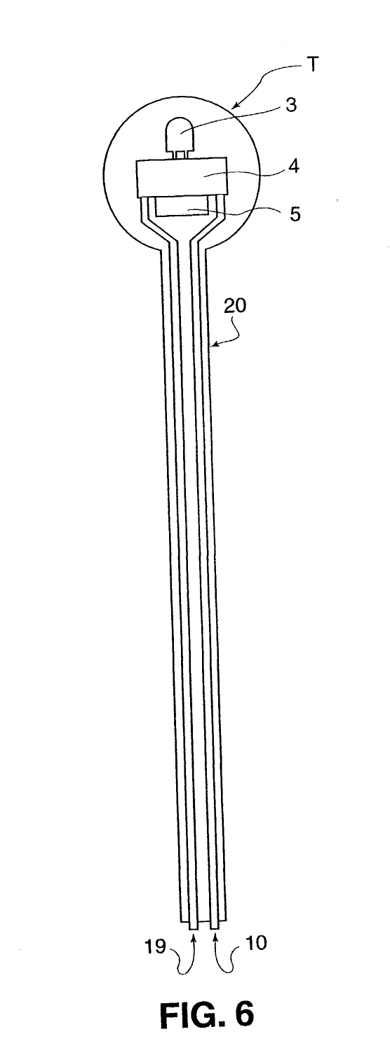

FIG. 6 represents a non limiting application of the present invention: a system for signalling or lighting (2), the upper part of which (T) is transparent or translucent and the bottom part of which is composed with a module (20) including the system of the present invention.

The material of the body of the article could vary, such as polycarbonate, resin, or other plastic materials, wood etc...

The system is integrated using different assembly technologies (glue, resin embedded, etc)

References (20,10,19,3,4,5,2) are explained above.

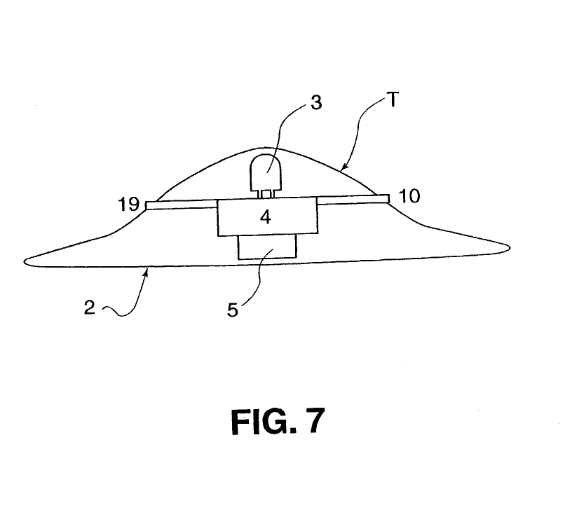

FIG. 7 represents a non limiting application of the invention: a low level liquid detector (2), the upper part of which (T) is transparent or translucent, and the body of which is composed of a module (20) including the system of the present invention.

The material of the body of the article could vary, such as polycarbonate, resin, or other plastic materials, etc . . .

The system is integrated using different assembly technologies (glue, resin embedded, etc)

This article can be for example in a water dishes for domestic animals or outside breeding animals such as chickens etc. its density is designed to prevent the article from floating. The electronic is adapted so that the lighting source (3) does not switch as long as the water is above the sensors (19), that means as long as the as long as the water connects the two sensors. As soon as the circuit is opened due to a lack of water, the lighting source lights up. References (20,10,19,3,4,5,2) are explained above.

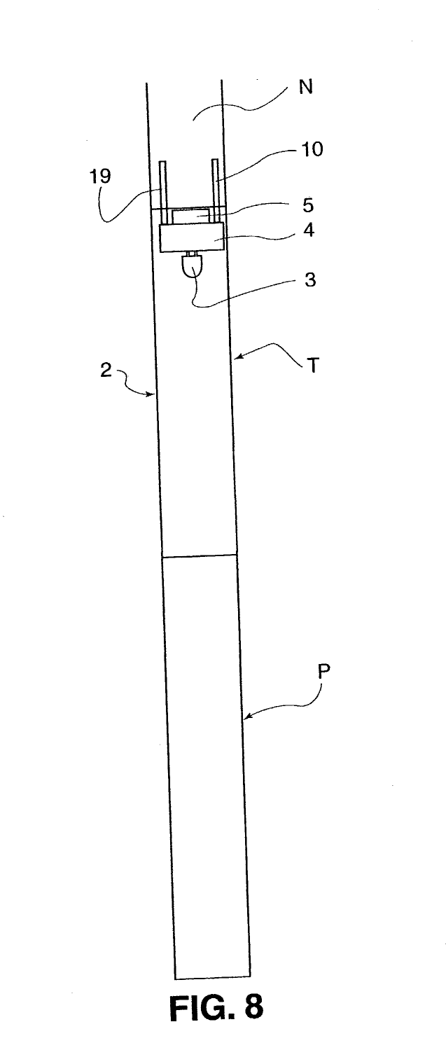

FIG. 8 represents a non limiting application of the present invention: a lighting system (2) such as a torch for instance for the ski slopes, the upper part of which (T) is transparent or translucent, and the body of which is composed of a module (20) including the system of the present invention.

The material of the article could vary, such as polycarbonate, resin, or other plastic materials, wood etc . . .

The system is integrated using different assembly technologies (glue, resin embedded, etc)

References 20,10,19,3,4,5,2 are explained above.

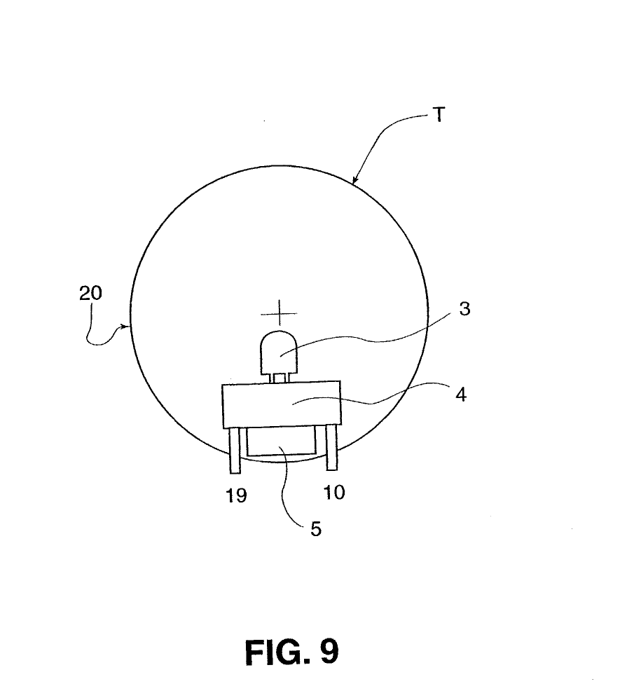

FIG. 9 represents a non limiting application of the present invention: a lighting system (2) to be used in swimming pool or other water places, the upper part of which (T) is transparent or translucent, and the body part of which is composed with a module (20) including the system of the present invention.

The density of the product is designed so that the article floats at the surface. We could also imagine a heavier system which drawn but applications are more restricted (aquariums, etc)

The material of the article could vary, such as polycarbonate, resin or other plastic materials, etc . . .

The system is integrated using different assembly technologies (glue, resin embedded, etc)

References (20,10,19,3,4,5,2) are explained above.

### EXAMPLE

FIG. 2

According to the invention, the electronic system is composed with a “Darlington” transistor type BCV27 from Fairchild™ or BC 517 from Motorola™ or Philips™ (t1) with its base (b) polarized to the negative side of the power supply (gnd) with a resistance of high value (r1), which maintained it in an inactive state (zero current) when the system is not in use.

When a current is appearing (even a small one), between the base (b) through the limiting resistance (r2) of medium value, between contact (e1) and contact (e2) linked with the positive side of power supply (+), the transistor (t1) becomes conductor and feeds the electro luminescent diode (e1) connected between its collector(c) and the positive side of the power supply (+), the emitter (e) from (t1) is connected to the negative of the power supply (gnd), the transistor (t1) is totally blocked when not in operation (storage or not in use) and does not let current go between its collector (c) and its emitter (e). The electro luminescent diode (el1) connected to the positive of the power supply (+) does not consume any current.

The invention covers all kind of articles which includes the above described system and integrated using different assembly technology such as glue, resin embedded, etc.

The invention covers all type of article of this kind, characterised by the fact that the material which composed the article could vary, such as glass, crystal, polycarbonate, resin, other plastic material, compressed paper, cardboard, wood, etc.

The purpose of the invention are multiple and concerns all small size objects or articles for which it is interesting, funny or useful to integrate the independent glow system for long term use, such as for instance to a non limiting extend:

Glasses, cups, mugs, flasks, bottles (contact by the liquid or by the hand)

Lights, candles, pens, individual light sticks for concert viewers

Indication of ground, wall or ceiling by fixing the light sticks to these places

Decorative products

Toys

Floatable articles for swimming pool decoration (contact with water)

Ashtray (contact with the temperature)

Pacifier and other sweets for babies

Decoration of present boxes (contact when the present is opened by exposure of the sensor to the light)

Luminous decoration for the clothes, hair etc.

Sticks or torches eventually flashing, for parades, ski slopes, etc.

Glow belt for domestic animals

Detector of water absence for instance in water dishes for domestic animals, birds, flower vase with water level etc.

Detector of a level of a solid (contact, when the level of the solid is below a chosen level, by activating a photoelectric cell with the daylight previously hidden by the presence of the solid). For instance birdseed, dried animal food, industrial products in a granular shape

Fishing buoy, which lights up as soon as the fish is caught and the buoy sensors are in contact with the water

Safety sticks which light up when they are in contact with the water (man overboard signal system)

And all other similar uses

The invention concerns all articles and applications, which appear relevant to the competent person. The invention also covers all the way of manufacture and all the applications, which are directly accessible to the competent person after reading the present document and with its own knowledge.

1. A small or very small size glow-in-the-dark independent system (1), which could be adapted or integrated in articles (2) including at least a lighting source (3), at least a control electronic (4) and at least a power source (5). The control electronic is composed of:
A device (8), which commands the illumination and extinction of the lighting source(s) in response to external stimuli through sensors(s) (19). The device (8) is composed of a “Darlington” transistor which is polarized using electronic components selected and adjusted to remain it in an inactive state (that means a conductivity of nil) when the system is stored or not in action
A device (6), which reduces to nil the power and lighting source consumptions during storage or when the system is not in action.

2. The system according to paragraph 1 but characterized by the fact that the control electronic (4) is composed with a device 7, which reduces the time to get illuminated for the electronic system and for the lighting elements after a period of no use.

3. The system according to paragraph 1 or 2 characterized by the fact it is packaged in a box (20).

4. The system according to any one of the paragraph 1 to 3 characterised by the fact that the control electronic (4) is composed of a device (9), which can temporise the illumination and/or light extinction, modify the lighting intensity to create flashing lighting, sparks, and special similar effects, eventually in response to (with one or many sensor(s) (10)) sound, visual or temperature external stimulations, such as synchronisation with external sound intensity or external light intensity, and similar effects.

5. The system according to the paragraph 4 characterized by the fact that the sensors (10) are humidity sensors, or light contrast sensors, or sound frequency sensors reacting to stimuli such as a finger tap, or sound level in the room or variation of such external stimuli.

6. The system according to any one of the paragraph 1 to 5 characterised by the fact that the sensors (19) can be all types of sensors able to send a signal towards the electronic device (4) and more precisely the illumination/extinction module (8), such as humidity sensor, temperature sensor, or contact sensor which close the electrical circuit when a liquid is present.

7. The system according to any one of the paragraphs 1 to 6 characterised by the fact that the sensors (19) and/or (10) are located outside the surface of the article (2) or next to the surface of the article (2).

8. The system according to any one of the paragraph 1 to 7 characterised by the fact that the energy consumption nil means the energy consumption in storage or when the system is not in use is zero, or extremely low, from 0.000 A/h to 0.00001 A/h, or few micro amperes/h.

9. The system according to any one of the paragraphs 1 to 8 characterised by the fact that the “Darlington” transistor is also polarised with electrical components similar or different from the previous ones and selected and adjusted so that the illumination of the system requires a very small polarised current of few microamperes.

10. The system according to any one of paragraph 1 to 9 characterised by the fact that the any contact between sensors 19 will stop illumination, for instance, the empty glass will light up and the light disappear when the glass is filled up.

11. The system according to any one of the paragraph 9 to 10 characterised by the fact the electronic system is composed with a “Darlington” transistor type BCV27 from Fairchild™ or BC 517 from Motorola™ or Philips™ (t1) with its base (b), polarized to the negative side of the power supply (gnd) with a resistance of high value (r1), which maintained it in an inactive state (zero current) when the system is not in use.
When a current is appearing (even a small one), between the base (b) through the limiting resistance (r2) of medium value, between contact (e1) and contact (e2) linked with the positive side of power supply (+), the transistor (t1) becomes conductor and feeds the electro luminescent diode (el1) connected between its collector(c) and the positive side of the power supply (+), the emitter (e) from (t1) is connected to the negative of the power supply (gnd), the transistor (t1) is totally blocked when not in operation (storage or not in use) and does not let current go between its collector (c) and its emitter (e). The electro luminescent diode (el1) connected to the positive of the power supply (+) does not consume any current.

12. Articles characterised by the fact it includes a system according to paragraph 1 to 11 integrated by various technologies (glue, resin embedding)

13. Articles according to paragraph 12 characterised by the fact the material which composed the products can vary, such as glass, crystal, polycarbonate, resin, other plastic material, compressed paper, cardboard, wood.

14. Application of the system to any of the following items:
Glasses, cups, mugs, flasks, bottles (contact by the liquid or by the hand)
Lights, candles, pens, individual light sticks for concert viewers.
Indication of ground, wall or ceiling by fixing the light sticks to this places.
Decorative products
Toys
Floatable articles for swimming pool decoration (contact with water)
Ashtray (contact with the temperature)
Pacifier and other sweets for babies
Decoration of present boxes (contact when the present is opened by exposure of the sensor to the light)
Luminous decoration for the clothes, hair.
Sticks or torches eventually flashing, for parades, ski slopes.
Glow belt for domestic animals
Detector of water absence for instance in water dishes for domestic animals, birds, flower vase with water level
Detector of a level of a solid (contact, when the level of the solid is below a chosen level, by activating a photoelectric cell with the daylight previously hidden by the presence of the solid). For instance birdseed, dried animal food, industrial products in a granular shape.
Fishing buoy, which lights up as soon as the fish is caught and the buoy sensors are in contact with the water.
Safety sticks which light up when they are in contact with the water (man overboard signal system)
